(19) United States
(12) Patent Application Publication
(10) Pub. No.: US 2008/0235152 A1
(43) Pub. Date: Sep. 25, 2008

(54) ACHIEVEMENT AND PRESERVATION FUNDS

(75) Inventors: John O'Brien, Corona Del Mar, CA (US); Sakhawat M. Khan, Atherton, CA (US); Michael Edesess, Golden, CO (US); Miguel Palacios, Berkeley, CA (US); Dan Jack Ransenberg, Sausalito, CA (US); Ke Tang, Cambridge (GB)

Correspondence Address: KNOBBE MARTENS OLSON & BEAR LLP, 2040 MAIN STREET, FOURTEENTH FLOOR, IRVINE, CA, 92614, US

(73) Assignee: MARKET RISK AUCTIONS, LLC, Corona del Mar, CA (US)

(21) Appl. No.: 12/018,072

(22) Filed: Jan. 22, 2008

Related U.S. Application Data
(60) Provisional application No. 60/881,935, filed on Jan. 23, 2007.

(51) Int. Cl. G06Q 40/00

(52) U.S. Cl. 705/36 R

(57) ABSTRACT

A computer-implemented method of locking-in investment gains can include initializing an investment fund having a net asset value per share. The investment fund can include assets allocated to at least a discount instrument and a derivative instrument, where the discount instrument provides a floor value of the net asset value per share. The method can further include selecting a target value for the investment fund. In addition, in some instances, the method can include reinitializing the investment fund in response to one or more of the following: (a) the investment fund at least achieving the target value and (b) expiration of an investment period of the investment fund. Reinitializing the investment fund can include rolling over the assets of the investment fund.

### CROSS-REFERENCE TO RELATED APPLICATIONS

This application claims priority from U.S. Provisional Application No. 60/881,935 filed Jan. 23, 2007, entitled “The Achievement and Preservation Funds,” the disclosure of which is hereby incorporated by reference in its entirety.

### BACKGROUND

### Description of the Related Technology

Determining the best mix of investment assets to invest in is a challenge faced by many individuals, corporations, and charitable institutions. Many investment vehicles are available, such as stocks, bonds, and cash equivalents. However, investing in one or the other can have downsides. An investor, for example, may invest his or her assets in bonds or cash equivalents, which provide a modest rate of return over a period of time. Investing solely in bonds or cash equivalents, however, provides little or no upside potential to the investor.

Alternatively, if the investor invests in stocks, the volatility of stocks introduces a risk that the investor's savings will be lost. Thus, a mix of stocks, bonds, cash equivalents, and/or other assets may be desired. Without guidance as to the proper mix, however, the investor's portfolio may still be exposed to significant risk of loss or little upside potential.

### SUMMARY OF SOME EMBODIMENTS

In various embodiments, a computer-implemented method of managing an investment fund to lock in gains and reduce losses can include creating a investment fund comprising a plurality of shares, where each share corresponds to a first discount instrument and a first derivative instrument. The first discount instrument can have a discount price being less than a maturity value of the first discount instrument. The maturity value can be a floor value for the net asset value per share of the investment fund at an end of an investment period. The first derivative instrument can have a value based at least in part on a value of an underlying asset. In certain embodiments, a net asset value per share of the investment fund is based at least in part on a combined value of the first discount instrument and the first derivative instrument.

The method can further include selecting a target value for the net asset value per share of the investment fund. This target value can be higher than the floor value. If the net asset value per share of the investment fund at least achieves the target value prior to expiration of the investment period, the method can include rolling over assets of the investment fund into a second discount instrument and a second derivative instrument, such that gains in the investment fund are locked in. If the investment period expires prior to the net asset value per share of the investment fund achieving at least the target value, the method can also include rolling over the assets of the investment fund into the second discount instrument and the second derivative instrument, where the net asset value per share of the investment fund at expiration of the investment period at least equals the floor value.

Certain implementations of a computer-implemented method of locking-in investment gains can include initializing an investment fund having a net asset value per share. The investment fund can include assets allocated to at least a discount instrument and a derivative instrument, where the discount instrument provides a floor value of the net asset value per share. The method can further include selecting a target value for the investment fund. In addition, in some instances, the method can include reinitializing the investment fund in response to one or more of the following: (a) the investment fund at least achieving the target value and (b) expiration of an investment period of the investment fund. Reinitializing the investment fund can include rolling over the assets of the investment fund.

In addition, in certain embodiments a computer-implemented method of managing investments includes using an investor's assets to purchase at least a first reserve asset and a first active asset. The first active asset can have a value based at least in part on a first underlying. The method can further include selecting a target value of the first active asset. In addition, in response to a value of the first active asset reaching at least the target value, the method can include: selling the first reserve asset and the first active asset to provide second assets and using the second assets to purchase at least a second reserve asset and a second active asset. The second active asset can have a value based at least in part on a second underlying.

Neither this summary nor the following detailed description purports to define the inventions disclosed herein. The inventions disclosed herein are defined by the claims.

### BRIEF DESCRIPTION OF THE DRAWINGS

FIG. 1 is a bar graph diagram depicting certain embodiments of an investment fund's net asset value per share over time;

FIG. 2 is a block diagram depicting certain embodiments of a share of the investment fund depicted over time;

FIG. 3A is a graph diagram depicting certain embodiments of underlying asset values of a derivative instrument over time;

FIG. 3B is a graph diagram depicting certain embodiments of discount instrument values over time;

FIG. 4 is a flowchart diagram depicting certain embodiments of a process for managing an investment fund; and

FIG. 5 is a block diagram depicting a computer system for providing and/or managing investment funds in accordance with certain embodiments.

### DETAILED DESCRIPTION OF EXEMPLARY EMBODIMENTS

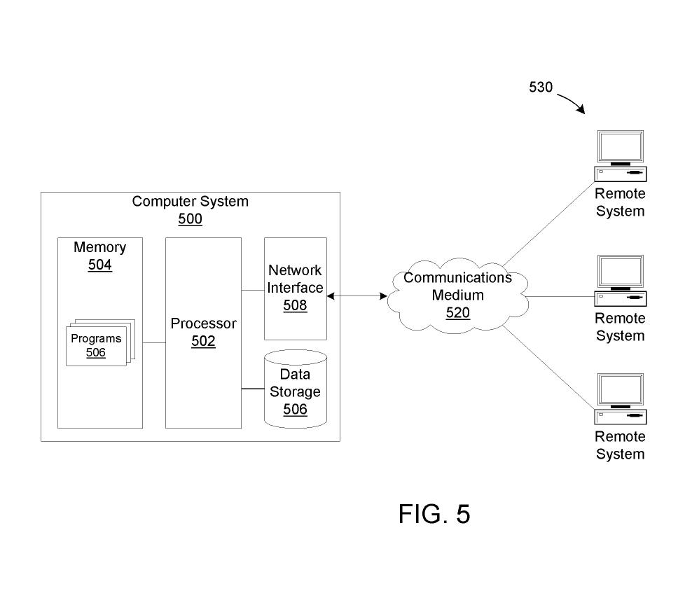

Several different computer-implemented processes will now be described for managing investment funds. These processes may be embodied individually or in any combination in a multi-user computer system, such as the computer system described below with respect to FIG. 5.

As described above, without guidance as to a proper mix of investments, an investor's portfolio can be exposed to significant risk of loss of principal or have little chance of obtaining significant gains. Thus, in certain embodiments, systems and methods are described herein for providing investment vehicles that enable investors to preserve their principal while having the potential of receiving significant gains. In various implementations, these investment vehicles can beneficially lock-in gains over time, provide protection against losses, and link periods of investments.

The features of these systems and methods will now be described with reference to the drawings summarized above. Throughout the drawings, reference numbers are re-used to indicate correspondence between referenced elements. The drawings, associated descriptions, and specific implementation are provided to illustrate certain embodiments of the inventions disclosed herein and not to limit the scope thereof.

In addition, methods and processes described herein are not limited to any particular sequence, and the blocks or states relating thereto can be performed in other sequences that are appropriate. For example, described blocks or states may be performed in an order other than that specifically disclosed, or multiple blocks or states may be combined into a single block or state.

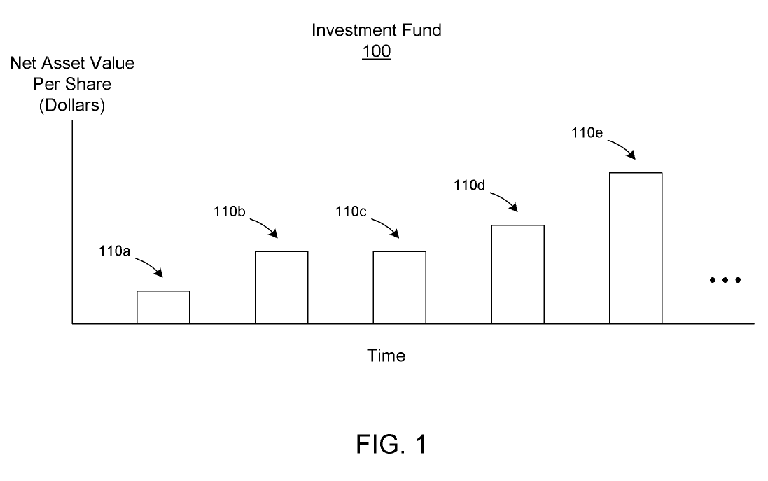

One example of an investment fund 100 that reduces or eliminates some or all of the problems described above is illustrated in FIG. 1. This investment fund 100 can be a common investment scheme or the like having multiple investors. Each investor can receive shares in the investment fund 100 in proportion to the amount of assets the investor invests in the fund. Each share has a value that can be determined by dividing the net asset value (NAV) of the fund 100 by the number of shares in the fund 100. This value can be referred to as the NAV per share.

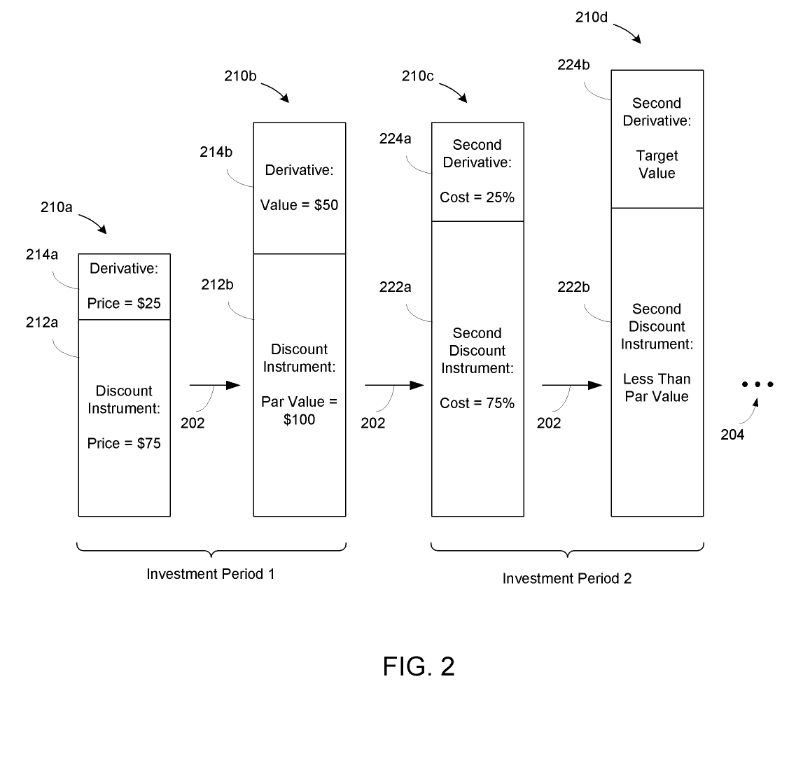

The investment fund 100 can be structured as an investment program having a sequence of linked investment periods. FIG. 1 illustrates a graph of example NAVs per share 110 of the investment fund 100 over a series of example investment periods. Each example NAV per share 110 shown is a NAV per share of the investment fund 100 at the end of an investment period. Thus, the NAV per share 110a is an example NAV per share at the end of a first investment period, the NAV per share 110b is an example NAV per share at the end of the next investment period, and so on. Advantageously, the investment fund 100 can be structured such that the NAV per share 110 increases or stays the same between investment periods. Thus, the investment fund 100 in certain embodiments experiences no losses between periods and locks in any gains between periods. More detailed embodiments of the structure of investments in the investment fund 100 are described below with respect to FIG. 2.

In certain embodiments, there are at least two ways to end each investment period and cause a new period to begin. In low growth investment environments, the investment period can last for a full predefined time interval, such as five years. In higher growth investment environments, in certain embodiments the investment period can end and a new period begin when the NAV per share reaches a certain target value or when certain assets in the investment fund 100 reach a target value.

Whether the current investment period ends at a predetermined time interval or upon reaching of a target value, in certain embodiments the gains in the NAV per share 110 can be “locked-in” by, for example, rolling over the assets of the fund 100 into a new investment period. Alternatively, if there are no gains, the NAV per share 110 at the end of a given period will be the same or substantially the same as the initial NAV per share at the beginning of the period. However, during an investment period the NAV per share in certain embodiments can potentially fall below the initial NAV per share at the beginning of the period or rise above it but not quite reach the target value. Thus, as long as an investor remains in the investment fund 100, in certain embodiments his or her investment periods can be linked. The linked investment periods can produce an asset growth profile that looks like a staircase having a series of steps, each step of varying length (up to the predetermined time interval) and height (reflecting any gains). This “staircase” effect can be seen in FIG. 1, as the NAV per share 110 at the end of each investment period grows or stays the same compared to the previous NAV per share 110.

In certain embodiments, the investment fund 100 is an open-ended fund. Investors can therefore enter into the fund 100 or opt out of the fund 100 at any time. Alternatively, investors can enter the fund at the start of a new period. The investment fund 100 can also be a closed fund, exchange-traded fund, or other type of fund in various implementations.

Additionally, in certain embodiments new assets can be added to the investment fund 100 at the start of a new investment period. Because investors may wish to add assets to the investment fund 100 more often, additional investment funds 100 with similar investment strategies can be opened over time to satisfy demand. Thus, multiple investment funds 100 can be used as a family of funds, each fund 100 being identified by its start date.

FIG. 2 illustrates an example progression of an example share's 210 NAV per share in an investment fund, such as the investment fund 100 described above. For simplicity in illustrating certain aspects of the share 210, only one share 210 is shown. However, the investment fund can potentially include many shares 210. Advantageously, assets corresponding to the share 210 are allocated such that losses between periods are minimized and gains between periods are locked in.

The share 210 is shown progressing through two investment periods, investment period 1 and investment period 2. Arrows 202 denote the progression of the share 210 through these investment periods. While two investment periods are shown, ellipses 204 indicate that the share 210 can continue to progress through additional investment periods.

For ease of illustration, the NAV of the share 210a at the start of investment period 1 is chosen to be $100. Other amounts may be chosen without limitation. In various embodiments, the assets of the share 210a can be used to purchase financial instruments. In the depicted embodiment, these financial instruments include a discount instrument 212a and a derivative instrument 214a.

In certain embodiments, the discount instrument 212a can be any financial instrument that may be purchased at a discount price from a par value at maturity. More generally, in certain embodiments the discount instrument 212 can be any instrument having a reasonably certain value at a specific future point in time. The discount instrument 212a can therefore increase in value from the discount price to a final value (e.g., par) over time, providing a gain in value of the share 210a. In one implementation, the discount instrument 212a is a discount bond, such as a zero coupon bond. In other implementations, the discount instrument 212a can be a treasury bill, a discount note from Freddie Mac or Federal Home Loan Banks, a discount bond having a coupon, a Banker's Acceptance, certain forms of commercial paper, gilt strips (e.g., sovereign debt strips), futures contracts payable in kind, combinations of the same, and the like. The discount instrument 212a can be inflation-protected or nominal. Multiple discount instruments 212a can be used in place of one discount instrument 212a, which may include any combination of these or other discount instruments 212a.

The derivative instrument 214, in certain implementations, can be any financial instrument whose price is derived directly or indirectly from one or more underlying assets or underlying economic indicators, which is sometimes referred to as an underlying. The derivative instrument 214 can be, for example, any type of option contract, such as but not limited to a European, American, put, call, collar, straddle, digital (binary), ladder, cliquet or ratchet, cliquet knock-in barrier, combinations of the same, and the like. Other possible derivative instruments 214 can include futures contracts, forward contracts, swaps, combinations of the same, and the like. The underlying can be any security, such as a stock, bond, currency, commodity, interest rate, market index (e.g., single market, global market, or the like), economic indicator, ratio of securities or economic indicators, combinations of the same, or the like. In implementations where the derivative instrument 214 is a call option, for example, the value of the derivative instrument 214 can increase as the value of the underlying increases.

Advantageously, the discount instrument 212a can be chosen such that the discount instrument 212a has a par value at maturity that is equal to the initial value of the share 210a. Thus, the par value of the discount instrument 212a can be a floor value for the share 210a. In certain embodiments, the discount instrument 212a can therefore be considered as an example of a reserve asset, providing a reserve value to the share 210, below which value the share 210 will not drop. As described below, this reserve asset need not be a discount instrument 212a in certain embodiments, but can instead be a more volatile reserve asset.

Using the example $100 value of the share 210a, a discount instrument 212a can be purchased having a par value of $100 at maturity. The discount price of the discount instrument 212a might be, for example, $75 (or 75% of the value of the share 210a). The remaining $25 (or 25%) can be used to purchase one or more derivative instruments 214a or fractions thereof, optionally less any transaction costs. The number of derivative instruments 214a that may be purchased can depend on the price of the derivative instruments 214a, which can further depend on market forces. In the present example, one derivative instrument 214a is purchased for $25.

Over time, the value of the derivative instrument 214a can fluctuate based on the fluctuating value of its underlying. The derivative instrument 214a could, for instance, provide a high return for the share 210 or add no value to the share 214a at all. The derivative instrument 214a can therefore in various embodiments be considered as an example of an active asset that can have potentially higher volatility and/or gains than a reserve asset (e.g., the discount instrument 212a). Advantageously, even if the value of the derivative instrument 214a were to fall to zero, since the discount instrument 214 will mature to $100 by the end of the first investment period, the value of the share 210a will be $100 at the end of the first investment period. This value is equal to the initial value of the share 210a. Thus, in certain embodiments there is no loss to the value of the share 210a during the first investment period. Conversely, any gain in the derivative instrument 214a is a gain for the share 210a.

The share 210b illustrates one possible scenario of values of the discount instrument 212b and the derivative instrument 214b. The discount instrument 212b has reached a par value of $100. The derivative instrument 214b has reached a value of $50. This value could be reached, for example, if the derivative instrument were a call option having a strike price of $100 and an underlying value of $150 at the end of the first investment period. The combined value of the instruments 212b, 214b of the example share 210b is therefore $150 at the end of the first investment period.

If the investor wishes to continue investing in the investment fund, the investor can continue on to the second investment period. The assets of the share 210b could then be rolled over into new financial instruments. This rolling over process can include purchasing the new financial instruments. More generally, new financial instruments could be purchased or swapped with the instruments 212b, 214b without going through a rollover process.

In certain embodiments, these financial instruments include a second discount instrument 222a and a second derivative instrument 222b. Different financial instruments can be chosen in other embodiments. The mix of assets allocated to the discount instrument 222a and the derivative instrument 224a in the share 210c can be the same as or different from the mix of assets allocated in the share 210a.

Similar to above, the second discount instrument 222a could be purchased at a discount price such that the par value of the second discount instrument 222a at maturity is equal to the value of the share 210c. In one example embodiment, this value can be 75% of the value of the share 210c. Remaining assets, e.g., 25%, can be used to purchase one or more second derivative instruments 224a. Other mixes of the financial instruments 222, 224 can be chosen without limitation.

Unlike the first investment period, the example second investment period shown does not end at the maturity of the discount instrument 222a. Rather, the second investment period ends upon the reaching of some predetermined target value. In one implementation, this target value can be a target NAV value per share, e.g., the NAV for the share 210. In another embodiment, the target value can be a target NAV of the investment fund. In another embodiment, the target value can be a value of the second derivative instrument 224b or the value of an underlying of the second derivative instrument 224b. In still another embodiment, the target value can be a value of the gain of the share 210c. Other target values or combinations of target values may also be chosen.

The combined values of the second discount instrument 222b and the second derivative instrument 224b at the end of the second investment period result in a new value for the share 210, represented as the share 210d. This combined value of the share 210d can be rolled over into a third investment period (not shown). Advantageously, rolling over the assets of the share 210d or otherwise purchasing new financial instruments can lock in gains achieved at the end of the second investment period.

It should be noted that the first and second periods are described as ending based on different events for illustrative purposes only. In other embodiments, the first investment period could end up reaching a target value, or both periods could end upon reaching a target value. Moreover, neither period could end based on reaching a target value, but rather both could end at a predetermined time. Over a lifetime of an investment fund, investment periods can randomly end based on reaching target values or based on reaching a predetermined time.

While the share 210 has been described above as having a discount instrument as a reserve asset and a derivative as an active asset, in other embodiments other instruments or investments may be used as reserve assets and/or active assets. For example, non-discount reserve assets can be used in place of the discount instruments 212, 222. In one embodiment, a non-discount reserve asset can be a commodity such as a precious metal or metals (e.g., gold), a stock, an index fund, or a host of other investment products. The price fluctuations of the non-discount reserve asset can act as a relative floor to the value of the share 210. In the case of certain commodities such as gold, the non-discount reserve asset can potentially provide a better return than a discount reserve asset when certain equity markets or currencies are in a downturn. Using a reserve asset with more volatility and/or upside potential than certain discount instruments can provide investors with a potentially higher rate of return on their share 210 or shares. In one implementation using non-discount reserve assets, the target value can be the NAV of the investment fund or the NAV per share. Likewise, the share 210 can include active assets other than options, such as stocks, indexes, futures, or the like that may increase or decrease the volatility or risk of the active asset.

In addition, the discount and derivative instruments 212, 214, 222, and 224 described above have been described in the context of a share 210 of an investment fund. However, in certain embodiments these instruments could be bought and sold independent of any investment fund and achieve some or all of the same benefits. For example, an investor could maintain a personal portfolio of assets by purchasing and selling, or otherwise rolling over, any of the financial instruments described herein. The investor could perform these transactions personally, or alternatively, a brokerage firm, financial advisor, or the like could perform these transactions on behalf of the investor.

In certain embodiments, one or more or all the financial instruments in the investment fund can be sold, purchased, or swapped with new financial instruments within an investment period independent of whether an end of period has been reached or whether the target value has been reached.

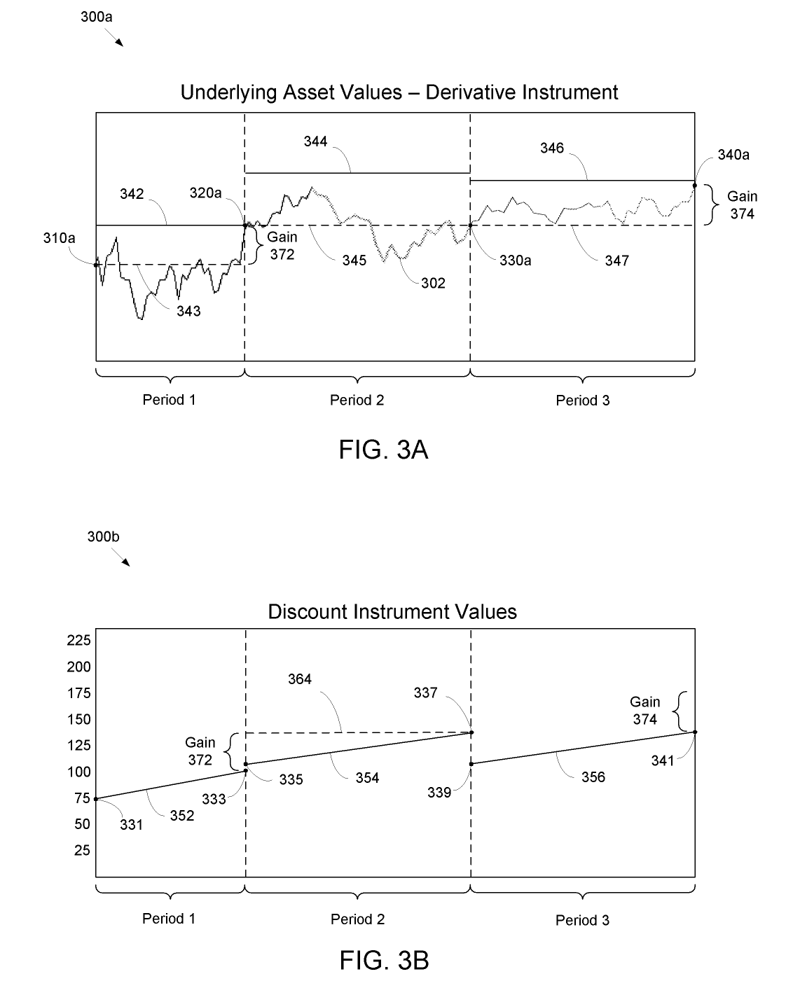

FIGS. 3A and 3B depict plots 300a, 300b of example derivative and discount instrument values over multiple investment periods. The plot 300a of FIG. 3A illustrates the values of an underlying asset of example derivative instruments. The plot 300b of FIG. 3B illustrates values of various example discount instruments. FIG. 3B also superimposes gains of the derivative instruments of FIG. 3A over the values of the discount instruments. The investment periods in FIG. 3B are the same as the investment periods in FIG. 3A.

Turning to FIG. 3A, a trace 302 representing values of an underlying over time are shown over three investment periods. Different derivative instruments may be purchased at the start of each period, each having a value based at least in part on the underlying values shown. However, in alternative embodiments, fewer than three derivative instruments may be used for all three periods, by using, for example, ladder or ratchet-style instruments. In addition, while a single underlying is shown for three instruments, different underlyings may be used for each instrument in alternative embodiments.

Four specific values are highlighted at points 310a, 320a, 330a, and 340a intersecting the trace 302. These four values include a value at point 310a, which is at the start of the first period, a value at point 320a at the end of the first period and start of the second period, a value at point 330a at the end of the second period and start of the third period, and a value at point 340a at the end of the third period. Thus, the plot 300a of certain embodiments illustrates an instantaneous rollover between periods. In alternative embodiments, this rollover might not be instantaneous. The end values of a period might therefore not coincide with the start values of a subsequent period.

In certain embodiments, the value of the underlying at the start of a period is used as the strike price for a derivative instrument during that period. The strike price may be chosen based on other criteria, however. For example, the strike price can be the value of the underlying adjusted suitably by an exchange rate (e.g., Dollar vs Renminbi, or Yen or Pound). Adjustment can also be done by the inflation rate, average life expectancy, any suitable economic or non-economic parameter or any risk adjustment parameter.

A dotted line 343 extends from the value at point 310a at the start of the first period to the end of the first period. Similar dotted lines 345 and 347 are used in the second and third periods, respectively. The dotted lines 343, 345, and 347 are used to visually illustrate differences between each period's initial value at points 310a, 320, 330a with each period's ending value at points 320a, 330a, 340a, respectively. A solid line 342, 344, 346 in each respective investment period represents a target value of the underlying. As described above, if the target value is reached, then in certain embodiments an investment period ends in order to lock in gains. Otherwise, if the target value is not reached, the investment period can continue until the end of a predefined period of time.

The trace 302 in the example first investment period shown reaches the target value 342 at point 320a. The first investment period therefore ends and the second investment period begins at the point 320a. By beginning a new investment period (e.g., by rolling over assets), a gain 372 between the value at point 320a and the value at point 310a is captured or locked in.

The trace 302 at the point 330a at the end of the second investment period does not reach the target value 344. Therefore, the second investment period continues until a predetermined period of time is reached. At the end of this period, the value of the trace 302 at point 330a is equal to the value at point 320a at the start of the second investment period. Thus, there is no gain in the second investment period. Note that, in certain embodiments, the trace 302 will reach zero value if the derivative instrument expires at 330a.

The trace 302 at the point 340a at the end of the third investment period also does not reach the target value 346. Therefore, the third investment period continues until a predetermined period of time is reached. In the illustrated example, this period of time is equal to the length of time of the second investment period. In practice, the predetermined length of time can be varied for each investment period. At the end of the third investment period, the value at point 340a is greater than the initial value of the investment period at point 330a. Thus, even though the target value 346 was not reached, there is a gain 374 in the third investment period. This gain 374 is the difference between the value at point 340a and the value at point 330a.

Turning to FIG. 3B, traces 352, 354, and 356 represent values of example discount instruments during first, second, and third respective investment periods. The values at points 331, 335, and 339 are the initial values of the discount instruments at the start of their respective investment period. These values at points 331, 335, and 339 represent the discount purchase price of the discount instruments. The values at points 333, 337, and 341 are the ending values of the discount instruments at the end of their respective investment periods. These values at points 333, 337, and 341 represent the par value of the discount instruments at maturity.

The value of the gain 372 is shown superimposed on the first investment period. The total NAV per share at the end of the first period is the sum of the value at the point 333 and the value of the gain 372. No gain is shown at the end of the second period, as the value of the underlying in FIG. 3A did not increase beyond its initial value at the start of the second period. Thus, the total value per share at the end of the second period is equal to the value at the point 337. By assistance of the dotted line 364, one can see that the value at the point 337 is equal to the NAV per share at the end of the first period. Thus, even though the underlying did not gain in the value, the NAV per share at the end of the second period did not suffer an overall loss.

Similar to the gain 372, the gain 374 is superimposed on the third investment period. The total NAV per share at the end of the third period is therefore the sum of the value at the point 341 and the value of the gain 374.

It should be noted that if an investor opts out before a target value is reached or before the end of a period is reached, the NAV per share at the time of opting out can be at a lower value than the NAV per share at the start of an investment period. This is because the discount instrument may not have yet reached par value when the investor opts out. However, an investor who opts out during an investment period can still receive gains if the NAV per share is greater than the initial NAV per share at the start of the investment period.

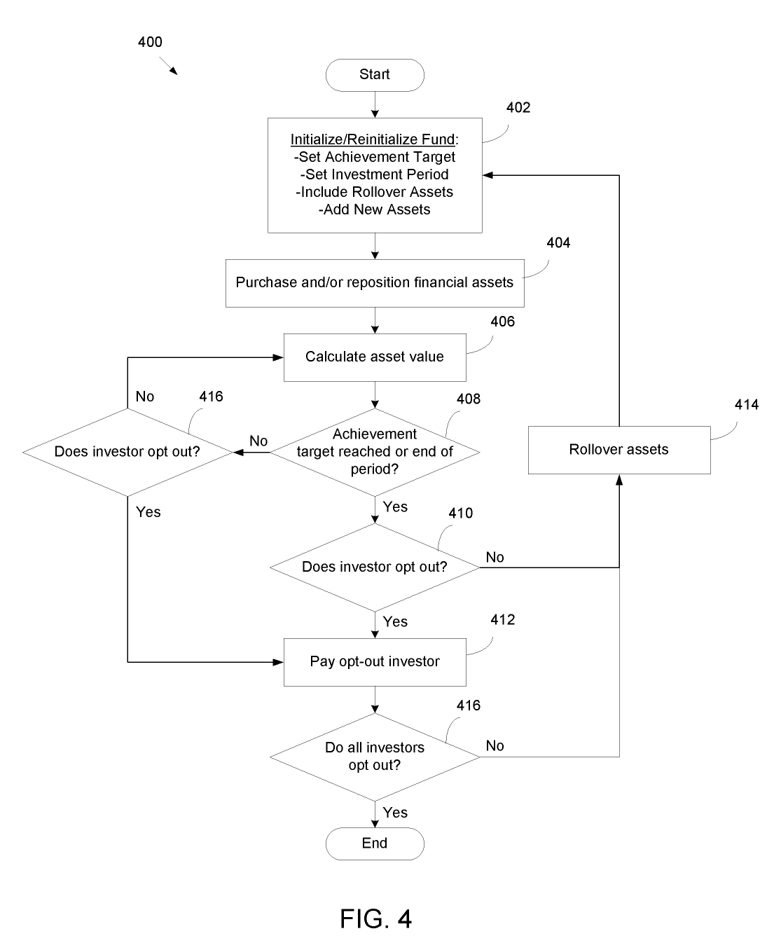

FIG. 4 depicts certain embodiments of a process 400 for managing an investment fund. The process 400 can advantageously implement the principles of any of the investment funds described above. The process 400 can be implemented by a computer system in certain embodiments, such as the computer system described below with respect to FIG. 5.

At block 402, an investment fund is initialized to the start of a first investment period or reinitialized at the start of subsequent investment periods. This initialization or reinitialization can include setting an achievement target, setting a length of time for an investment period, including rollover assets, and adding new assets. The achievement target and length of time for the investment period can be different for different investment periods. New assets can be added by investors when desired in certain implementations.

In certain embodiments, as described above, setting the achievement target can include setting a target derivative value, a target underlying value, a target NAV or NAV per share, combinations of the same, or the like. In one embodiment, for example, both a target underlying value and a target NAV value per share can be set. If either target is reached (see, e.g., block 408), a new investment period can be initialized.

At block 404, financial assets are purchased and/or repositioned. These financial assets can include financial instruments such as discount instruments and derivative instruments. At the start of each period, new financial assets can be purchased using the rollover assets and optionally any new assets added. Alternatively, the financial assets in place at the end of the previous period can be repositioned. For example, a derivative instrument such as a cliquet knock-in barrier could be repositioned to have a gain value locked in, a new strike price established, and a new target gain value established at the start of an investment period.

Continuing, asset values are calculated at block 406. Asset values may be calculated at regular intervals such as daily, weekly, monthly, or other intervals. Calculating asset values can include calculating the NAV or NAV per share of the investment fund.

It is determined at block 408 whether the achievement target for the current period has been reached, or alternatively, whether an end to the current investment period has been reached. If neither have occurred, it is further determined at block 416 whether any investors (one or more) wish to opt out of the investment fund. If any investors opt out, at block 412 these investors are paid according to their shares in the fund. Otherwise, flow of the process 400 returns to block 406, where asset value is eventually calculated.

Alternatively, if the achievement target has been reached, or if the period has ended, it is determined at block 410 whether one or more investors opt out. As above, if one or more investors have opted out, they are paid at block 412. Otherwise, their assets in the fund are rolled over at block 414, and the fund is reinitialized at block 402. In addition, it is determined at 416 whether all investors have opted out. If so, the process 400 ends. Otherwise, the process 400 proceeds to block 414, where assets are rolled over.

FIG. 5 depicts certain embodiments of a computer system 500. The computer system 500 system of various embodiments facilitates managing investment funds by calculating one or more of underlying values, discount instrument values, NAV or NAV per share, combinations of the same, and the like. In addition, the computer system 500 can obtain financial parameters and related price quotes from remote systems 520 over a communications medium 512 such as the Internet or the like. The computer system 500 can use this financial information to assist in managing the investment fund.

Illustrative computer systems 500 include general purpose (e.g., PCs) and special purpose (e.g., graphics workstations) computer systems, which may include one or more servers, databases, and the like. More generally, any processor-based system may be used as a computer system 500.

The computer system 500 of certain embodiments includes a processor 502 for processing one or more software programs 506 stored in memory 504, for accessing data stored in hard data storage 508, and for communicating with a network interface 510. The network interface 510 provides an interface to the communications medium 512 and/or other networks.

In an embodiment, the computer system 500 further includes, by way of example, one or more processors, program logic, or other substrate configurations representing data and instructions, which operate as described herein. In other embodiments, the processor can comprise controller circuitry, processor circuitry, processors, general purpose single-chip or multi-chip microprocessors, digital signal processors, embedded microprocessors, microcontrollers and the like.

The computer system 500 can further communicate via the communications medium 512 with one or more remote systems 520 using the network interface 510 to publish information about the investment fund. In other embodiments, the network interface 510 or the communications medium 512 can be any communication system including by way of example, dedicated communication lines, telephone networks, wireless data transmission systems, two-way cable systems, customized computer networks, interactive kiosk networks, automatic teller machine networks, interactive television networks, and the like.

In one embodiment, the remote systems 520 are websites on the World Wide Web. In other embodiments the remote systems 520 can be any device that interacts with or provides data, including by way of example, any internet site, private networks, network servers, video delivery systems, audio-visual media providers, television programming providers, telephone switching networks, teller networks, wireless communication centers and the like.

Each of the processes and algorithms described above may be embodied in, and fully automated by, code modules executed by one or more computers or computer processors. The code modules may be stored on any type of computer-readable medium or computer storage device. The processes and algorithms may also be implemented partially or wholly in application-specific circuitry. The results of the disclosed processes and process steps may be stored, persistently or otherwise, in any type of computer storage. In one embodiment, the code modules may advantageously be configured to execute on one or more processors. In addition, the code modules may comprise, but are not limited to, any of the following: software or hardware components such as software object-oriented software components, class components and task components, processes methods, functions, attributes, procedures, subroutines, segments of program code, drivers, firmware, microcode, circuitry, data, databases, data structures, tables, arrays, variables, or the like.

The various features and processes described above may be used independently of one another, or may be combined in various ways. All possible combinations and subcombinations are intended to fall within the scope of this disclosure. In addition, certain method or process steps may be omitted in some implementations.

While certain embodiments of the inventions disclosed herein have been described, these embodiments have been presented by way of example only, and are not intended to limit the scope of the inventions disclosed herein. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of the inventions disclosed herein.

What is claimed is:

1. A computer-implemented method of managing an investment fund to lock in gains and reduce losses, the method comprising:
creating a investment fund comprising a plurality of shares, wherein each share corresponds to:
a first discount instrument, the first discount instrument having a discount price, the discount price being less than a maturity value of the first discount instrument, the maturity value being a floor value for the net asset value per share of the investment fund at an end of an investment period; and
a first derivative instrument, the first derivative instrument having a value based at least in part on a value of an underlying asset;
wherein a net asset value per share of the investment fund is based at least in part on a combined value of the first discount instrument and the first derivative instrument;
selecting a target value for the net asset value per share of the investment fund, the target value being higher than the floor value;
if the net asset value per share of the investment fund at least achieves the target value prior to expiration of the investment period, rolling over assets of the investment fund into a second discount instrument and a second derivative instrument, such that gains in the investment fund are locked in; and
if the investment period expires prior to the net asset value per share of the investment fund achieving at least the target value, rolling over the assets of the investment fund into the second discount instrument and the second derivative instrument, wherein the net asset value per share of the investment fund at expiration of the investment period at least equals the floor value.

2. The method of claim 1, wherein the discount instrument comprises a discount bond.

3. The method of claim 2, wherein the discount bond comprises a zero coupon bond.

4. The method of claim 1, wherein the derivative instrument comprises an option.

5. A computer-implemented method of locking-in investment gains, the method comprising:
initializing an investment fund having a net asset value per share, the investment fund comprising assets allocated to at least a discount instrument and a derivative instrument, wherein the discount instrument provides a floor value of the net asset value per share;
selecting a target value for the investment fund; and
reinitializing the investment fund in response to one or more of the following: (a) the investment fund at least achieving the target value and (b) expiration of an investment period of the investment fund, wherein reinitializing the investment fund comprises rolling over the assets of the investment fund.

6. The method of claim 5, wherein selecting a target value for the investment fund comprises selecting a target net asset value per share.

7. The method of claim 5, wherein selecting a target value for the investment fund comprises selecting a target net asset value of the investment fund.

8. The method of claim 5, wherein selecting a target value for the investment fund comprises selecting a target value of the derivative instrument.

9. The method of claim 5, wherein selecting a target value for the investment fund comprises selecting a target value of an underlying of the derivative instrument.

10. The method of claim 5, wherein the discount instrument comprises a discount price having a value less than a maturity value of the discount instrument, the maturity value being the floor value for the net asset value per share.

11. The method of claim 5, wherein rolling over the assets of the investment fund comprises purchasing a second discount instrument and a second derivative instrument.

12. The method of claim 5, wherein the discount instrument comprises a discount bond.

13. The method of claim 12, wherein the discount bond comprises a zero coupon bond.

14. The method of claim 5, wherein the derivative instrument comprises an option.

15. A computer-implemented method of managing investments, the method comprising:
using an investor's assets to purchase at least a first reserve asset and a first active asset, the first active asset having a value based at least in part on a first underlying;
selecting a target value of the first active asset; and
in response to a value of the first active asset reaching at least the target value:
selling the first reserve asset and the first active asset to provide second assets; and
using the second assets to purchase at least a second reserve asset and a second active asset, the second active asset having a value based at least in part on a second underlying.

16. The method of claim 15, wherein the first reserve asset provides a floor value to the second assets.

17. The method of claim 15, wherein the first reserve asset comprises a discount instrument.

18. The method of claim 15, wherein the first reserve asset comprises an investment in a commodity.

19. The method of claim 15, wherein the first active asset comprises a derivative instrument.

20. The method of claim 15, further comprising: in response to an investment period expiring, selling the first reserve asset and the second active asset to provide the second assets, and using the second assets to purchase at least the second reserve asset and the second active asset.
